(19) United States
(12) Patent Application Publication
(10) Pub. No.: US 2011/0187840 A1
(43) Pub. Date: Aug. 4, 2011

(54) THREE DIMENSIONAL DISPLAY AND METHOD THEREOF

(75) Inventors: Yue-Li Chao, Taoyuan County (TW); Chun-Lun Pan, Tainan City (TW); Chun-Chieh Chiu, Taoyuan County (TW); Chien-Hung Chen, Taipei County (TW)

(73) Assignee: CHUNGHWA PICTURE TUBES, LTD., Taoyuan (TW)

(21) Appl. No.: 12/757,051

(22) Filed: Apr. 9, 2010

(30) Foreign Application Priority Data
Feb. 4, 2010 (TW) 99103364

(51) Int. Cl. H04N 13/04

(52) U.S. Cl. 348/53; 348/E13.075

(57) ABSTRACT

A three dimensional display and a method thereof are provided. The display includes an image display device and a shutter glasses. The image display device receives a video signal to display a left eye frame or a right eye frame, and outputs a shutter synchronization signal according to whether the left eye frame or the right eye frame is displayed. The shutter glasses is coupled to the image display device to open a left eye glass or a right eye glass according to the shutter synchronization signal. Therefore, the display and the method prevents the left eye and the right eye from receiving an incomplete frame.

### CROSS-REFERENCE TO RELATED APPLICATION

This application claims the priority benefit of Taiwan application serial no. 99103364, filed on Feb. 4, 2010. The entirety of the above-mentioned patent application is hereby incorporated by reference herein and made a part of specification.

### BACKGROUND OF THE INVENTION

1. Field of the Invention

The invention generally relates to a three dimensional display technique, and more particularly to a three dimensional display and a display method thereof.

2. Description of Related Art

As technology progresses and advances, people's needs for fulfillment on a material and a spiritual level have not lessened but instead, have increased. People are eager to express their imagination through a three dimensional (3D) display, so as to vividly experience an effect of being personally in a scene. Therefore, how to present a 3D image or video with a display has become a major objective that current 3D display techniques seek to achieve.

With regards to outer appearances, 3D display techniques can be roughly divided into stereoscopic techniques which require a user to wear a specially designed pair of glasses, and auto-stereoscopic techniques which directly allow viewing with a naked eye. In particular, stereoscopic 3D display techniques may be divided into color filter glasses, polarizing glasses, and shutter glasses, etc. The operating principle of a stereoscopic 3D display utilizes the eye glasses to select the left and right eye frames displayed by the 3D display, so that the left and right eye respectively sees the left and right eye frames for generating a 3D visual effect.

FIG. 1 is a schematic view of a conventional 3D image display system. Referring to FIG. 1, in a 3D image display system 10, a media playback device 30 generates a video signal VS and a shutter synchronization signal SS according to a media content. Specifically, the video signal VS controls an image display device 110 of a 3D display 100 to display a corresponding image, whereas the shutter synchronization signal SS controls a shutter glasses to open a left eye glass or a right eye glass. When the image display device 110 displays a left eye frame, the shutter glasses 120 opens the left eye glass and shuts the right eye glass, so that a left eye receives the left eye frame. When the image display device 110 displays a right eye frame, the shutter glasses 120 opens the right eye glass and shuts the left eye glass, so that a right eye receives the right eye frame.

In order to enhance an image 3D effect and to prevent a residual image, a typical design usually entails opening the shutter glasses after the image is fully displayed. However, since the video signal VS and the shutter synchronization signal SS are generated by the media playback device 50, the media playback device 50 is required to calculate a full display time of the image in accordance with a process time delay by an internal circuitry of the image display device 110, and accordingly generate the shutter synchronization signal SS. Moreover, due to differences in the internal circuitry designs and in the structures of panels adopted for the image display device 110, the process time delay of the internal circuitry in the image display device 110 may not be the same. When the media playback device 50 misjudges or fails to support the internal circuitry of the image display device 110, an incorrect shutter synchronization signal SS may be generated. Furthermore, the incorrect shutter synchronization signal SS may cause the shutter glasses to open the lenses at an incorrect time, resulting in residual images and a deterioration of the image 3D effect.

### SUMMARY OF THE INVENTION

An aspect of the invention provides a three dimensional display that may accurately control the eye glasses of a shutter glasses to open according to display of corresponding frames.

An aspect of the invention provides a display method that may enhance a brightness of image display.

An aspect of the invention provides a display method, suitable for a three dimensional display including an image display device and a shutter glasses. The display method includes following steps. When a right eye frame is about to be written in the image display device, the image display device outputs a shutter synchronization signal to shut a left eye glass of the shutter glasses. When the right eye frame is written, the image display device outputs the shutter synchronization signal to open a right eye glass of the shutter glasses. When a left eye frame is about to be written in the image display device, the image display device outputs the shutter synchronization signal to shut the right eye glass of the shutter glasses. When the left eye frame is written, the image display device outputs the shutter synchronization signal to open a left glass of the shutter glasses.

According to an embodiment of the invention, the aforesaid step of the image display device outputting the shutter synchronization signal to shut the left eye glass of the shutter glasses, when the right eye frame is about to be written in the image display device, includes the image display device outputting the shutter synchronization signal to shut the left eye glass of the shutter glasses, when a start signal is enabled in a frame period corresponding to the right eye frame.

According to an embodiment of the invention, the aforesaid step of the image display device outputting the shutter synchronization signal to open the right eye glass of the shutter glasses, when the right eye frame is written, includes the image display device outputting the shutter synchronization signal to open the right eye glass of the shutter glasses, when a final data write pulse transmitted by a data latch signal in a frame period corresponding to the right eye frame changes from enabled to disabled.

According to an embodiment of the invention, the aforesaid step of the image display device outputting the shutter synchronization signal to open the right eye glass of the shutter glasses, when the right eye frame is written, includes the image display device outputting the shutter synchronization signal to open the right eye glass of the shutter glasses, when a last scan signal changes from enabled to disabled in a frame period corresponding to the right eye frame.

According to an embodiment of the invention, the aforesaid step of the image display device outputting the shutter synchronization signal to shut the right eye glass of the shutter glasses, when the left eye frame is about to be written in the image display device, includes the image display device outputting the shutter synchronization signal to shut the right eye glass of the shutter glasses, when the start signal is enabled in a frame period corresponding to the left eye frame.

According to an embodiment of the invention, the aforesaid step of the image display device outputting the shutter synchronization signal to open the left eye glass of the shutter glasses, when the left eye frame is written, includes the image display device outputting the shutter synchronization signal to open the left eye glass of the shutter glasses, when a final data write pulse transmitted by a data latch signal in a frame period corresponding to the left eye frame changes from enabled to disabled.

According to an embodiment of the invention, the aforesaid step of the image display device outputting the shutter synchronization signal to open the left eye glass of the shutter glasses, when the left eye frame is written, includes the image display device outputting the shutter synchronization signal to open the left eye glass of the shutter glasses, when a last scan signal changes from enabled to disabled in a frame period corresponding to the left eye frame.

According to an embodiment of the invention, the left eye glass and the right eye glass are preset to shut.

According to an embodiment of the invention, the left eye glass is opened in a first pulse transmitted by the shutter synchronization signal, and the right eye glass is opened in a second pulse transmitted by the shutter synchronization signal, wherein the first pulse and the second pulse are located in different frame periods.

An aspect of the invention provides a display method, suitable for a three dimensional display including an image display device and a shutter glasses. The display method includes the following steps. When the right eye frame is about to be written in the image display device, the image display device outputs the shutter synchronization signal to open the right eye glass and shut the left eye glass of the shutter glasses. When the left eye frame is about to be written in the image display device, the image display device outputs the shutter synchronization signal to open the left eye glass and shut the right eye glass of the shutter glasses. When the image display device displays a black frame, the image display device outputs the shutter synchronization signal to maintain a state of the left eye glass and a state of the right eye glass, wherein the black frame is displayed between the left eye frame and the right eye frame.

According to an embodiment of the invention, the aforesaid step of the image display device outputting the shutter synchronization signal to open the right eye glass and shut the left eye glass of the shutter glasses, when the right eye frame is about to be written in the image display device, includes the image display device outputting the shutter synchronization signal to open the right eye glass and shut the left eye glass of the shutter glasses, when the start signal is enabled in a frame period corresponding to the right eye frame.

According to an embodiment of the invention, the aforesaid step of the image display device outputting the shutter synchronization signal to open the left eye glass and shut the right eye glass of the shutter glasses, when the left eye frame is about to be written in the image display device, includes the image display device outputting the shutter synchronization signal to open the left eye glass and shut the right eye glass of the shutter glasses, when the start signal is enabled in a frame period corresponding to the left eye frame.

According to an embodiment of the invention, the left eye glass is opened with the shutter synchronization signal at a first level, and the right eye glass is opened with the shutter synchronization signal at a second level, wherein the first level is not the same as the second level.

An aspect of the invention provides a three dimensional display including an image display device and a shutter glasses. The image display device receives a video signal to display a left eye frame or a right eye frame, and the image display device outputs a shutter synchronization signal according to the left eye frame or the right eye frame. The shutter glasses is coupled to the image display device, and the shutter glasses opens one of a left eye glass and a right eye glass according to the shutter synchronization signal.

According to an embodiment of the invention, the aforementioned image display device includes a timing controller, a gate driver, a source driver, a display panel, and a synchronization signal generator. The timing controller receives the video signal, and the timing controller generates a start signal, a gate clock signal, and a data latch signal according to whether the left eye frame or the right eye frame is displayed. The gate driver is coupled to the timing controller, and the gate driver generates a plurality of scan signals according to the start signal and the gate clock signal. The source driver is coupled to the timing controller, and the source driver outputs a plurality of display data according to the data latch signal. The display panel is coupled to the gate driver and the source driver, and the display panel displays the left eye frame or the right eye frame by receiving the display data according to the scan signals. The synchronization signal generator is coupled to the timing controller, and the synchronization signal generator generates the shutter synchronization signal according to the start signal, the gate clock signal, or the data latch signal.

According to an embodiment of the invention, the aforementioned synchronization signal generator outputs the shutter synchronization signal to shut the left eye glass of the shutter glasses, when the start signal is enabled in a frame period corresponding to the right eye frame.

According to an embodiment of the invention, the aforementioned synchronization signal generator outputs the shutter synchronization signal to open the right eye glass of the shutter glasses, when a final data write pulse transmitted by the data latch signal in a frame period corresponding to the right eye frame changes from enabled to disabled.

According to an embodiment of the invention, the aforementioned synchronization signal generator outputs the shutter synchronization signal to open the right eye glass of the shutter glasses, when a last scan signal of the plurality of scan signals changes from enabled to disabled in a frame period corresponding to the right eye frame.

According to an embodiment of the invention, the aforementioned synchronization signal generator outputs the shutter synchronization signal to shut the right eye glass of the shutter glasses, when the start signal is enabled in a frame period corresponding to the left eye frame.

According to an embodiment of the invention, the aforementioned synchronization signal generator outputs the shutter synchronization signal to open the left eye glass of the shutter glasses, when a final data write pulse transmitted by the data latch signal in a frame period corresponding to the left eye frame changes from enabled to disabled.

According to an embodiment of the invention, the aforementioned synchronization signal generator outputs the shutter synchronization signal to open the left eye glass of the shutter glasses, when a last scan signal of the plurality of scan signals changes from enabled to disabled in a frame period corresponding to the left eye frame.

According to an embodiment of the invention, the aforementioned synchronization signal generator outputs the shutter synchronization signal to open the right eye glass and shut the left eye glass of the shutter glasses, when the start signal is enabled in a frame period corresponding to the right eye frame.

According to an embodiment of the invention, the aforementioned synchronization signal generator outputs the shutter synchronization signal to open the left eye glass and shut the right eye glass of the shutter glasses, when the start signal is enabled in a frame period corresponding to the left eye frame.

In summary, in the three dimensional display and the display method thereof according to embodiments of the invention broadly described herein, the three dimensional display outputs the shutter synchronization signal according to a written frame and a frame written state, so as to control the shutter glasses to open the corresponding eye glass according to the displayed frame. Accordingly, an issue in which the image display device opens the eye glasses of the shutter glasses during a write period of the display data, causing the left and right eyes to receive an incomplete frame may be prevented.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional three dimensional (3D) image display system.

FIG. 2 is a schematic view of a 3D image display system in accordance with an embodiment of the invention.

FIG. 3 is a waveform diagram of a start signal, a data latch signal, and a shutter synchronization signal depicted in FIG. 2 in accordance with an embodiment of the invention.

FIG. 4 is a waveform diagram of the start signal, the gate clock signal, and the shutter synchronization signal depicted in FIG. 2 in accordance with an embodiment of the invention.

FIG. 5 is a waveform diagram of the start signal and the shutter synchronization signal depicted in FIG. 2 in accordance with an embodiment of the invention.

FIG. 6 is a flow chart illustrating a display method in accordance with an embodiment of the invention.

FIG. 7 is a flow chart illustrating a display method in accordance with another embodiment of the invention.

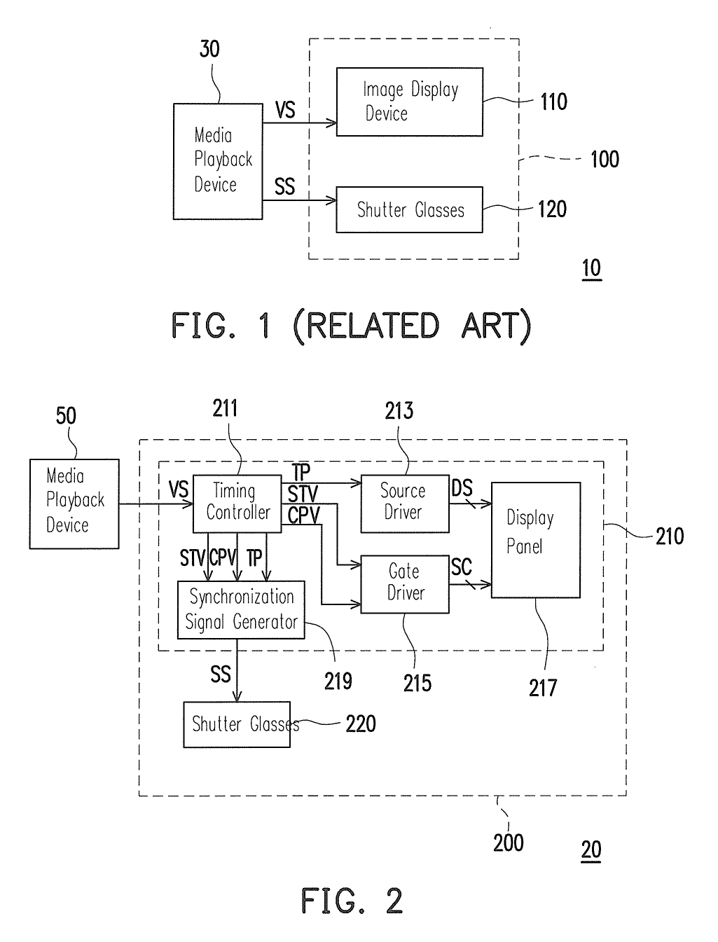

### DESCRIPTION OF EMBODIMENTS

FIG. 2 is a schematic view of a 3D image display system in accordance with an embodiment of the invention. Referring to FIG. 2, in a 3D image display system 20, a media playback device 50 provides a video signal VS, and a 3D display 200 displays a 3D image according to the video signal VS. The media playback device 50 is a personal computer or a media disk playback device, for example. In addition, the video signal VS may be transmitted through a D-subminiature (D-sub) Interface, a Digital Visual Interface (DVI), or a High Definition Multimedia Interface (HDMI) transmission interface. The 3D display 200 includes an image display device 210 and a shutter glasses 220.

The image display device 210 receives the video signal VS, displays a left eye frame or a right eye frame according to the video signal VS, and generates and outputs a shutter synchronization signal SS according to the display of the left eye frame or the right eye frame. The shutter glasses 220 is coupled to the image display device 210, and the shutter glasses 220 opens one of a left glass or a right glass thereof in accordance with the shutter synchronization signal SS. The shutter synchronization signal SS may be transmitted through a wired interface or a wireless interface such as infrared radiation, Bluetooth, or Wifi, for example.

The image display device 210 includes a timing controller 211, a source driver 213, a gate driver 215, a display panel 217, and a synchronization signal generator 219. The timing controller 211 receives the video signal VS, and a start signal STV, a gate clock signal CPV, and a data latch signal TP are generated by the timing controller 211 according to whether a frame data transmitted by the video signal VS displays the left eye frame or the right eye frame. The gate driver 215 is coupled to the timing controller 211, and the gate driver 215 generates a plurality of scan signals SC according to the start signal STV and the gate clock signal CPV. The source driver 213 is coupled to the timing controller 211, and the source driver 213 outputs a plurality of display data DS according to the data latch signal TP. The display panel 217 is coupled to the gate driver 215 and the source driver 213, and the display panel 217 displays the left eye frame or the right eye frame by receiving the display data DS according to the scan signals SC. The synchronization signal generator 219 is coupled to the timing controller 211, and the synchronization signal generator 219 generates the shutter synchronization signal SS according to the start signal STV, the gate clock signal CPV, or the data latch signal TP.

Assume that the video signal VS alternates between transmitting the left eye frame and right eye frame, and the left eye glass and the right eye glass of the shutter glasses 220 are preset to shut when the shutter glasses 220 begins operating. When the right eye frame is about to be written in the display panel 217, the synchronization signal generator 219 outputs the shutter synchronization signal SS to shut the left eye glass of the shutter glasses 220. Moreover, when the right eye frame is written, the synchronization signal generator 219 outputs the shutter synchronization signal SS to open the right eye glass of the shutter glasses 220. Therefore, a full right eye frame may be provided to a right eye. When the left eye frame is about to be written in the display panel 217, the synchronization signal generator 219 outputs the shutter synchronization signal SS to shut the right eye glass of the shutter glasses 220. Moreover, when the left eye frame is written, the synchronization signal generator 219 outputs the shutter synchronization signal SS to open the left eye glass of the shutter glasses 220. Therefore, a full left eye frame may be provided to a left eye.

In light of the above description, according to whether the left eye frame or the right eye frame is about to be written in the display panel 217, or whether writing is complete, the image display device 210 outputs the shutter synchronization signal SS to control the shutter glasses 220 such that the left eye glass is open when the left eye frame is displayed, and the right eye glass is open when the right eye frame is displayed. Since the shutter synchronization signal SS is outputted according to a written frame in the image display device 210 as well as a frame write state, therefore, whether the left eye or the right eye receives an image may be controlled by when the frame is fully displayed. Hence, an incorrect synchronization signal SS causing the left eye and the right eye to receive an incomplete image may be prevented. Moreover, by referencing the start signal STV, the gate clock signal CPV, and the data latch signal TP, whether the frame is about to be written in the display panel 217 and whether the frame has been written may be determined, and further details are described hereafter.

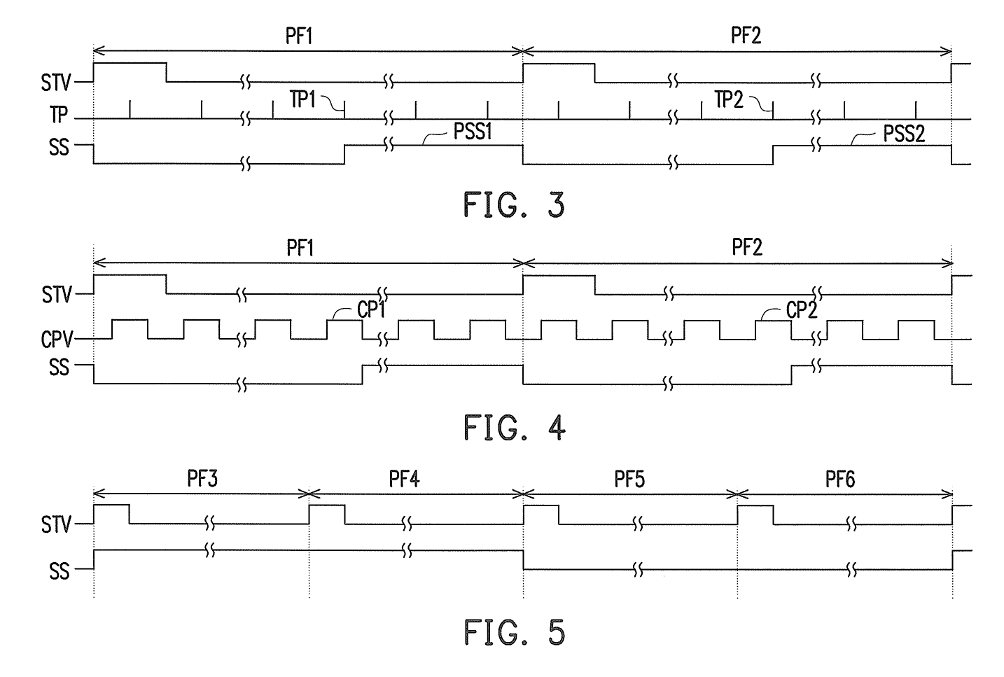

FIG. 3 is a waveform diagram of a start signal STV, a data latch signal TP, and a shutter synchronization signal SS depicted in FIG. 2 in accordance with an embodiment of the invention. Referring to FIGS. 2 and 3, assume here that in a frame period PF1 the right eye frame is displayed, and in a frame period PF2 the left eye frame is displayed. In light of the foregoing, when the start signal STV is enabled (e.g., the start signal STV is at a high level) in the frame period PF1, the synchronization signal generator 219 disables the shutter synchronization signal SS (e.g., the shutter synchronization signal SS is at a low level), so that the left eye glass of the shutter glasses 220 is shut. Therefore, when the right eye frame is about to be written in the display panel 217, the synchronization signal generator 219 outputs the shutter synchronization signal SS to shut the left eye glass of the shutter glasses 220.

Furthermore, in the frame period PF1 when a final data write pulse (e.g., a pulse TP1) of the data latch signal TP changes from enabled to disabled (e.g., the pulse TP1 is at the low level, and a last line of the display data DS is outputted to the display panel 217), the synchronization signal generator 219 enables the shutter synchronization signal SS (e.g., the shutter synchronization signal is at the high level), so that the right eye glass of the shutter glasses 220 is open. Therefore, when the right eye frame is written, the synchronization signal generator 219 outputs the shutter synchronization signal SS to open the right eye glass of the shutter glasses 220. When the start signal STV is enabled in the frame period PF2, the synchronization signal generator 219 disables the synchronization signal SS so that the right eye glass of the shutter glasses 220 is shut. Therefore, when the left eye frame is about to be written in the display panel 217, the synchronization signal generator 219 outputs the shutter synchronization signal SS to shut the right eye glass of the shutter glasses 220.

Furthermore, in the frame period PF2 when a final data write pulse (e.g., a pulse TP2) of the data latch signal TP changes from enabled to disabled (e.g., a last line of the display data DS in the left eye frame is outputted to the display panel 217), the synchronization signal generator 219 enables the shutter synchronization signal SS, so that the left eye glass of the shutter glasses 220 is open. Therefore, when the left eye frame is written, the synchronization signal generator 219 outputs the shutter synchronization signal SS to open the left eye glass of the shutter glasses 220.

In light of the foregoing, an open period of the right eye glass is a pulse width of a pulse PSS1, whereas an open period of the left eye glass is a pulse width of a pulse PSS2. Typically speaking, the open period of the eye glass is at least 10% of the frame period. More specifically, the pulse width of the pulse PSS1 is at least 10% of the frame period PF1, and the pulse width of the pulse PSS2 is at least 10% of the frame period PF2. Moreover, when a transmission time of the display data DS is decreased, the open period of the eye glass may be increased, and the open period may be increased up to 32% of a frame period.

FIG. 4 is a waveform diagram of the start signal STV, the gate clock signal CPV, and the shutter synchronization signal SS depicted in FIG. 2 in accordance with an embodiment of the invention. Referring to FIGS. 3 and 4, the foregoing embodiment uses the data latch signal TP to determine whether a frame is written, while the present embodiment uses the scan signals SC to determine whether a frame is written. Moreover, since the scan signals SC are generated according to the start signal STV and the gate clock signal CPV, the gate clock signal CPV may be used to determine whether the last scan signals SC are transmitted. In the present embodiment of the invention, assume that a pulse CP1 and a pulse CP2 correspond to a last scan signal SC in the frame periods PF1 and PF2.

Accordingly, in the frame period PF1 when a pulse CP1 corresponding to the last scan signal SC changes from enabled to disabled (e.g., a last line of the display data DS in the right eye frame is written in the display panel 217), the synchronization signal generator 219 enables the shutter synchronization signal SS, so that the right eye glass of the shutter glasses 220 is open. Moreover, in the frame period PF2 when a pulse CP2 corresponding to the last scan signal SC changes from enabled to disabled (e.g., a last line of the display data DS in the left eye frame is written in the display panel 217), the synchronization signal generator 219 enables the shutter synchronization signal SS, so that the left eye glass of the shutter glasses 220 is open.

It should be mentioned that, according to the present embodiment, a state of the last scan signal SC may be determined by a calculation, such as counting pulses of the gate clock signal CPV. However, in other embodiments of the invention, a signal line may be pulled from an output terminal of the last scan signal SC to the synchronization signal generator 219, so as to directly measure the state of the last scan signal SC. Furthermore, when the last scan signal SC change from enabled to disabled, the shutter synchronization signal SS is generated to open the eye glass corresponding to the frame.

Referring to FIG. 2, assume that the video signal VS alternates between transmitting the left eye frame, the black frame, and right eye frame, and assume a transmission order is a continuous succession of the left eye frame, the black frame, the right eye frame, the black frame, and back to the left eye frame. Under this circumstance, when the right eye frame is about to be written in the display panel 217, the synchronization signal generator 219 outputs the shutter synchronization signal SS to open the right eye glass and shut the left eye glass of the shutter glasses 220.

When the black frame is written and displayed in the display panel 217, the synchronization signal generator 219 outputs the shutter synchronization signal SS having the same level when the right eye frame is written, so as to maintain a shut state of the left eye glass and an open state of the right eye glass. When the left eye frame is about to be written in the display panel 217, the synchronization signal generator 219 outputs the shutter synchronization signal SS to open the left eye glass and shut the right eye glass of the shutter glasses 220. When the black frame is again written and displayed in the display panel 217, the synchronization signal generator 219 outputs the shutter synchronization signal SS having the same level when the left eye frame is written, so as to maintain the open state of the left eye glass and the closed state of the right eye glass.

FIG. 5 is a waveform diagram of the start signal STV and the shutter synchronization signal SS depicted in FIG. 2 in accordance with an embodiment of the invention. Referring to FIGS. 2 and 5, in the present embodiment of the invention, a frame period PF3 corresponds to the right eye frame, a frame period PF5 corresponds to the left eye frame, and a frame period PF4 and a frame period PF6 correspond to black frames. Moreover, when the shutter synchronization signal SS is enabled, the right eye glass of the shutter glasses 220 is opened, whereas the left eye glass of the shutter glasses 220 is shut. When the shutter synchronization signal SS is disabled, the left eye glass of the shutter glasses 220 is opened, whereas the right eye glass of the shutter glasses 220 is shut.

In the present embodiment, in the frame period PF3 when the start signal STV is enabled, the synchronization signal generator 219 outputs an enabled shutter synchronization signal SS to open the right eye glass and shut the left eye glass of the shutter glasses 220. Furthermore, in the frame period PF4 when the start signal STV is enabled, the synchronization signal generator 219 outputs the same shutter synchronization signal SS as in the frame period PF3. In other words, the level of the shutter synchronization signal SS is not changed. When the start signal STV is enabled in the frame period PF5, the synchronization signal generator 219 outputs a disabled shutter synchronization signal SS to open the left eye glass and shut the right eye glass of the shutter glasses 220. Moreover, in the frame period PF6 when the start signal STV is enabled, the synchronization signal generator 219 outputs the same shutter synchronization signal SS as in the frame period PF5. In other words, the level of the shutter synchronization signal SS is not changed.

According to the foregoing description, when the right eye glass is open (e.g., during the frame periods PF3 and PF4), the right eye frame is displayed half of the time, and the black frame is displayed the other half of the time. That is, a display time of the right eye frame is 50% of a time the right eye glass is open. When the left eye glass is open (e.g., during the frame periods PF5 and PF6), the left eye frame is displayed half of the time, and the black frame is displayed the other half of the time. That is, a display time of the left eye frame is 50% of a time the left eye glass is open. Therefore, a display time of the frames is 50% of an open period of the eye glass, thereby enhancing a brightness of the frame display.

Moreover, in the image display device 210, an overdriving technique is employed to increase a rate of writing the display data DS into the display panel 217. Taking 256 gray levels for example, the image display device 210 constructs an overdriving table of a size of 256×256, in order to determine overdriving values corresponding to grayscale values of a currently writing display data DS in accordance with grayscale values of a previous frame. However, when the video signal VS alternates between transmitting the left eye frame, the black frame, and right eye frame, since the one prior frame before the display of the left eye frame and the right eye frame is the black frame (e.g., a previous frame has a fixed 0 gray level), overdriving table may be reduced to a size of 256×1.

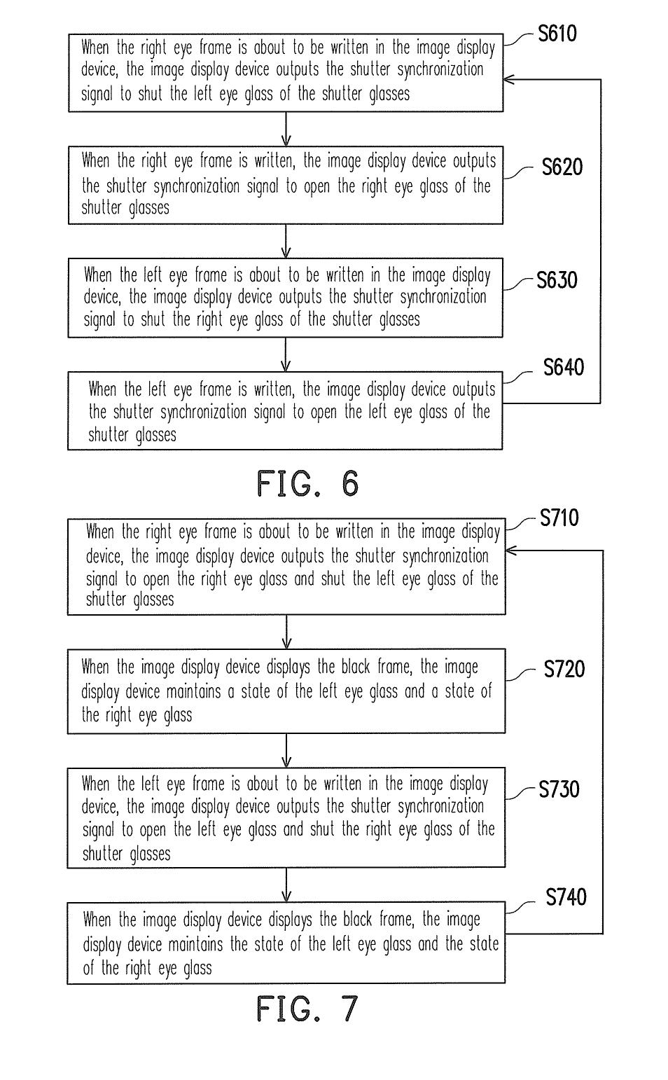

Accordingly, a display method may be described that is applicable when the video signal alternates between transmitting the left eye frame and the right eye frame. FIG. 6 is a flow chart illustrating a display method in accordance with an embodiment of the invention. Referring to FIG. 6, in the present embodiment, when the right eye frame is about to be written in the image display device, the image display device outputs the shutter synchronization signal to shut the left eye glass of the shutter glasses (a step S610). When the right eye frame is written, the image display device outputs the shutter synchronization signal to open the right eye glass of the shutter glasses (a step S620). When the left eye frame is about to be written in the image display device, the image display device outputs the shutter synchronization signal to shut the right eye glass of the shutter glasses (a step S630). When the left eye frame is written, the image display device outputs the shutter synchronization signal to open the left eye glass of the shutter glasses (a step S640). Thereafter, the step S610 is returned to and executed. The details of the display method of the present embodiment may be referred to the embodiments aforementioned, therefore the description is thus omitted herein.

Moreover, another display method may be described that is applicable when the video signal alternates between transmitting the left eye frame, the black frame, and the right eye frame. FIG. 7 is a flow chart illustrating a display method in accordance with another embodiment of the invention. Referring to FIG. 7, in the present embodiment, when the right eye frame is about to be written in the image display device, the image display device outputs the shutter synchronization signal to open the right eye glass and shut the left eye glass of the shutter glasses (a step S710). When the image display device displays the black frame, the image display device maintains a state of the left eye glass and a state of the right eye glass (a step S720). When the left eye frame is about to be written in the image display device, the image display device outputs the shutter synchronization signal to open the left eye glass and shut the right eye glass of the shutter glasses (a step S730). When the image display device displays the black frame, the image display device maintains the state of the left eye glass and the state of the right eye glass (a step S740). Thereafter, the step S710 is returned to and executed. The details of the display method of the present embodiment may be referred to the embodiments aforementioned, therefore the description is thus omitted herein.

In light of the foregoing, in the 3D display and the display method thereof according to embodiments of the invention broadly described herein, the 3D display outputs the shutter synchronization signal according to a written frame and a frame written state, so as to control the shutter glasses to open the corresponding eye glass according to the displayed frame. Accordingly, an issue in which the image display device opens the eye glasses of the shutter glasses during a write period of the display data, causing the left and right eyes to receive an incomplete frame may be prevented. Moreover, when the video signal alternates between transmitting the left and right eye frames and the black frame, the brightness of the frame display may be enhanced, and a memory size of the overdriving table may be decreased.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A display method, suitable for a three dimensional display comprising an image display device and a shutter glasses, the method comprising:
outputting a shutter synchronization signal with the image display device to shut a left eye glass of the shutter glasses, when a right eye frame is about to be written in the image display device;
outputting the shutter synchronization signal with the image display device to open a right eye glass of the shutter glasses, when the right eye frame is written;
outputting the shutter synchronization signal with the image display device to shut the right eye glass of the shutter glasses, when a left eye frame is about to be written in the image display device; and
outputting the shutter synchronization signal with the image display device to open the left eye glass of the shutter glasses, when the left eye frame is written.

2. The display method as claimed in claim 1, wherein the step of outputting the shutter synchronization signal with the image display device to shut the left eye glass of the shutter glasses, when the right eye frame is about to be written in the image display device comprises:
outputting the shutter synchronization signal with the image display device to shut the left eye glass of the shutter glasses, when a start signal is enabled in a frame period corresponding to the right eye frame.

3. The display method as claimed in claim 1, wherein the step of outputting the shutter synchronization signal with the image display device to open the right eye glass of the shutter glasses, when the right eye frame is written comprises:
outputting the shutter synchronization signal with the image display device to open the right eye glass of the shutter glasses, when a final data write pulse transmitted by a data latch signal in a frame period corresponding to the right eye frame changes from enabled to disabled.

4. The display method as claimed in claim 1, wherein the step of outputting the shutter synchronization signal with the image display device to open the right eye glass of the shutter glasses, when the right eye frame is written comprises:
outputting the shutter synchronization signal with the image display device to open the right eye glass of the shutter glasses, when a last scan signal changes from enabled to disabled in a frame period corresponding to the right eye frame.

5. The display method as claimed in claim 1, wherein the step of outputting the shutter synchronization signal with the image display device to shut the right eye glass of the shutter glasses, when the left eye frame is about to be written in the image display device comprises:
outputting the shutter synchronization signal with the image display device to shut the right eye glass of the shutter glasses, when a start signal is enabled in a frame period corresponding to the left eye frame.

6. The display method as claimed in claim 1, wherein the step of outputting the shutter synchronization signal with the image display device to open the left eye glass of the shutter glasses, when the left eye frame is written comprises:
outputting the shutter synchronization signal with the image display device to open the left eye glass of the shutter glasses, when a final data write pulse transmitted by a data latch signal in a frame period corresponding to the left eye frame changes from enabled to disabled.

7. The display method as claimed in claim 1, wherein the step of outputting the shutter synchronization signal with the image display device to open the left eye glass of the shutter glasses, when the left eye frame is written comprises:
outputting the shutter synchronization signal with the image display device to open the left eye glass of the shutter glasses, when a last scan signal changes from enabled to disabled in a frame period corresponding to the left eye frame.

8. The display method as claimed in claim 1, wherein the left eye glass and the right eye glass are preset to shut.

9. The display method as claimed in claim 1, wherein the left eye glass is opened in a first pulse transmitted by the shutter synchronization signal, and the right eye glass is opened in a second pulse transmitted by the shutter synchronization signal, wherein the first pulse and the second pulse are located in different frame periods.

10. A display method, suitable for a three dimensional display comprising an image display device and a shutter glasses, the method comprising:
outputting a shutter synchronization signal with the image display device to open a right eye glass and shut a left eye glass of the shutter glasses, when a right eye frame is about to be written in the image display device;
outputting the shutter synchronization signal with the image display device to open the left eye glass and shut the right eye glass of the shutter glasses, when a left eye frame is about to be written in the image display device; and
outputting the shutter synchronization signal with the image display device to maintain a state of the left eye glass and a state of the right eye glass, when the image display device displays a black frame, wherein the black frame is displayed between the left eye frame and the right eye frame.

11. The display method as claimed in claim 10, wherein the step of outputting the shutter synchronization signal with the image display device to open the right eye glass and shut the left eye glass of the shutter glasses, when the right eye frame is about to be written in the image display device comprises:
outputting the shutter synchronization signal with the image display device to open the right eye glass and shut the left eye glass of the shutter glasses, when a start signal is enabled in a frame period corresponding to the right eye frame.

12. The display method as claimed in claim 10, wherein the step of outputting the shutter synchronization signal with the image display device to open the left eye glass and shut the right eye glass of the shutter glasses, when the left eye frame is about to be written in the image display device comprises:
outputting the shutter synchronization signal with the image display device to open the left eye glass and shut the right eye glass of the shutter glasses, when a start signal is enabled in a frame period corresponding to the left eye frame.

13. The display method as claimed in claim 10, wherein the left eye glass is opened with the shutter synchronization signal at a first level, and the right eye glass is opened with the shutter synchronization signal at a second level, wherein the first level is not the same as the second level.

14. A three dimensional display, comprising:
an image display device receiving a video signal to display a left eye frame or a right eye frame, configured to output a shutter synchronization signal according to the left eye frame or the right eye frame; and
a shutter glasses coupled to the image display device, configured to open one of a left eye glass and a right eye glass according to the shutter synchronization signal.

15. The three dimensional display as claimed in claim 14, wherein the image display device comprises:
a timing controller receiving the video signal, configured to generate a start signal, a gate clock signal, and a data latch signal according to whether the left eye frame or the right eye frame is displayed.
a gate driver coupled to the timing controller, configured to generate a plurality of scan signals according to the start signal and the gate clock signal;
a source driver coupled to the timing controller, configured to output a plurality of display data according to the data latch signal;
a display panel coupled to the gate driver and the source driver, configured to receive the display data to display the left eye frame or the right eye frame according to the scan signals; and
a synchronization signal generator coupled to the timing controller, configured to generate the shutter synchronization signal according to the start signal, the gate clock signal, or the data latch signal.

16. The three dimensional display as claimed in claim 15, wherein the synchronization signal generator outputs the shutter synchronization signal to shut the left eye glass of the shutter glasses, when the start signal is enabled in a frame period corresponding to the right eye frame.

17. The three dimensional display as claimed in claim 15, wherein the synchronization signal generator outputs the shutter synchronization signal to open the right eye glass of the shutter glasses, when a final data write pulse transmitted by the data latch signal in a frame period corresponding to the right eye frame changes from enabled to disabled.

18. The three dimensional display as claimed in claim 15, wherein the synchronization signal generator outputs the shutter synchronization signal to open the right eye glass of the shutter glasses, when a last scan signal of the plurality of scan signals changes from enabled to disabled in a frame period corresponding to the right eye frame.

19. The three dimensional display as claimed in claim 15, wherein the synchronization signal generator outputs the shutter synchronization signal to shut the right eye glass of the shutter glasses, when the start signal is enabled in a frame period corresponding to the left eye frame.

20. The three dimensional display as claimed in claim 15, wherein the synchronization signal generator outputs the shutter synchronization signal to open the left eye glass of the shutter glasses, when a final data write pulse transmitted by the data latch signal in a frame period corresponding to the left eye frame changes from enabled to disabled.

21. The three dimensional display as claimed in claim 15, wherein the synchronization signal generator outputs the shutter synchronization signal to open the left eye glass of the shutter glasses, when a last scan signal of the plurality of scan signals changes from enabled to disabled in a frame period corresponding to the left eye frame.

22. The three dimensional display as claimed in claim 15, wherein the synchronization signal generator outputs the shutter synchronization signal to open the right eye glass and shut the left eye glass of the shutter glasses, when the start signal is enabled in a frame period corresponding to the right eye frame.

23. The three dimensional display as claimed in claim 15, wherein the synchronization signal generator outputs the shutter synchronization signal to open the left eye glass and shut the right eye glass of the shutter glasses, when the start signal is enabled in a frame period corresponding to the left eye frame.
